(19) United States
(12) Patent Application Publication
(10) Pub. No.: US 2025/0070444 A1
(43) Pub. Date: Feb. 27, 2025

(54) CAVITY RESONATOR AND FILTER HAVING THE SAME

(71) Applicant: Telefonaktiebolaget LM Ericsson (publ), Stockholm (SE)

(72) Inventors: Haiju Kang, Beijing (CN); Xueyuan Zhang, Beijing (CN); Weidong Wang, Beijing (CN)

(21) Appl. No.: 18/856,618

(22) PCT Filed: Apr. 14, 2022
(86) PCT No.: PCT/CN2022/086862

§ 371 Date: Oct. 13, 2024

(51) Int. Cl. H01P 7/10; H01P 1/208

(52) U.S. Cl. CPC H01P 7/105; H01P 1/2086

(57) ABSTRACT

A cavity resonator, comprising: a metal cavity; a first resonator rod extending in a first direction between a first wall and a second wall of the metal cavity; and a second resonator rod extending in a second direction between a third wall and a fourth wall of the metal cavity, the second direction being perpendicular to the first direction. The first resonator rod and the second resonator rod do not intersect each other. The first resonator rod is provided with a first dielectric body, and the second resonator rod is provided with a second dielectric body. The present disclosure also relates to a filter comprising the cavity resonator.

### TECHNICAL FIELD

The present disclosure generally relates to the technical field of communication device, and more particularly, to a dual-mode or triple-mode cavity resonator and a filter comprising the cavity resonator.

### BACKGROUND

This section introduces aspects that may facilitate better understanding of the present disclosure. Accordingly, the statements of this section are to be read in this light and are not to be understood as admissions about what is in the prior art or what is not in the prior art.

Base station (BS) is an important part of a mobile communication system, and may include a radio unit (RU) and an antenna unit (AU). Considering the installation/fixation/occupation, smaller volume and lighter weight is always an important evolution direction in BS design, including Legacy BS, Street Macro, Micro, Small Cell, and Advanced Antenna System (AAS).

In recent years, with the development of the 5th Generation (5G) communication, Multiple-Input and Multiple-Output (MIMO) technology is widely used, which requires a lot of filter units (FUs) to be integrated with AU or RU to save cost and space. For example, FUs may be soldered onto a radio mother board, a low pass filter (LPF) board, an antenna calibration (AC) board or a power splitter board. Thus, filters that are smaller and lighter with better performance are quite in demand.

Due to the insufficient reliability of ceramic waveguide (CWG) filters, cavity filters are widely used, which generally consists of a metal cavity and a plurality of resonators in the metal cavity. Traditional cavity filters are quite bulky, and ways of producing small cavity filters may include employing dual-mode or triple-mode cavity filter or manufacturing the metal cavity and/or the resonators from a sheet metal. In existing dual-mode or triple-mode cavity filters, a dielectric chip is arranged between each end of the resonator and the metal cavity, and thus the resonator cannot be integrally formed with the metal cavity.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide a novel and improved solution for dual-mode or triple-mode cavity filters.

According to a first aspect of the disclosure, there is provided a cavity resonator, comprising: a metal cavity; a first resonator rod extending in a first direction between a first wall and a second wall of the metal cavity; and a second resonator rod extending in a second direction between a third wall and a fourth wall of the metal cavity, the second direction being perpendicular to the first direction. The first resonator rod and the second resonator rod do not intersect each other, the first resonator rod is provided with a first dielectric body, and the second resonator rod is provided with a second dielectric body.

In an embodiment of the disclosure, each of the first resonator rod and the second resonator rod is grounded.

In an embodiment of the disclosure, the first resonator rod comprises a first part extending from the first wall of the metal cavity and a second part extending from the second wall of the metal cavity, with a first air gap being formed therebetween; and/or the second resonator rod comprises a first part extending from the third wall of the metal cavity and a second part extending from the fourth wall of the metal cavity, with a second air gap being formed therebetween.

In an embodiment of the disclosure, the first resonator rod extends from the first wall of the metal cavity towards the second wall of the metal cavity, and is spaced from the second wall with a first air gap being formed therebetween; and/or the second resonator rod extends from the third wall of the metal cavity towards the fourth wall of the metal cavity, and is spaced from the fourth wall with a second air gap being formed therebetween.

In an embodiment of the disclosure, the first dielectric body is a first dielectric chip provided at the first air gap; and/or the second dielectric body is a second dielectric chip provided at the second air gap.

In an embodiment of the disclosure, the first dielectric chip is grounded at one end or both ends thereof in the first direction; and/or the second dielectric chip is grounded at one end or both ends thereof in the second direction.

In an embodiment of the disclosure, the first dielectric chip is fixed to an end of the first resonator rod by welding; and/or the second dielectric chip is fixed to an end of the second resonator rod by welding.

In an embodiment of the disclosure, one end surface or both end surfaces of the first dielectric chip in the first direction is/are at least partially electroplated; and/or one end surface or both end surfaces of the second dielectric chip in the second direction is/are at least partially electroplated.

In an embodiment of the disclosure, an electroplating area of the first dielectric chip is smaller than, equal to, or larger than a surface area of the first resonator rod; and/or an electroplating area of the second dielectric chip is smaller than, equal to, or larger than a surface area of the second resonator rod.

In an embodiment of the disclosure, a first central hole is formed at an end of the first resonator rod, such that an electroplated layer of the first dielectric chip can be partially removed for frequency tuning; and/or a second central hole is formed at an end of the second resonator rod, such that an electroplated layer of the second dielectric chip can be partially removed for frequency tuning.

In an embodiment of the disclosure, the first dielectric chip is fixed to an end of the first resonator rod by using conductive glue; and/or the second dielectric chip is fixed to an end of the second resonator rod by using conductive glue.

In an embodiment of the disclosure, the first dielectric body is a first dielectric collar that encircles a portion of the first resonator rod; and/or the second dielectric body is a second dielectric collar that encircles a portion of the second resonator rod.

In an embodiment of the disclosure, the first dielectric collar takes the form of a cap, having an inner end surface facing an end surface of the first resonator rod in the first direction; and/or the second dielectric collar takes the form of a cap, having an inner end surface facing an end surface of the second resonator rod in the second direction.

In an embodiment of the disclosure, the first dielectric collar is at least partially electroplated; and/or the second dielectric collar is at least partially electroplated.

In an embodiment of the disclosure, a tuning screw or a tuning tab is provided at the first wall and/or the second wall, adjacent to the first resonator rod; and/or a tuning screw or a tuning tab is provided at the third wall and/or the fourth wall, adjacent to the second resonator rod.

In an embodiment of the disclosure, the cavity resonator further comprises a metal part or a metallization structure, which forms an angle of 30-60 degree with the first direction and the second direction.

In an embodiment of the disclosure, the cavity resonator further comprises a third resonator rod extending in a third direction between a fifth wall and a sixth wall of the metal cavity, the third direction being perpendicular to the first direction and the second direction. The third resonator rod does not intersect the first resonator rod or the second resonator rod, and is provided with a third dielectric body.

In an embodiment of the disclosure, the third resonator rod is grounded.

In an embodiment of the disclosure, the third resonator rod comprises a first part extending from the fifth wall of the metal cavity and a second part extending from the sixth wall of the metal cavity, with a third air gap being formed therebetween; or the third resonator rod extends from the fifth wall of the metal cavity towards the sixth wall of the metal cavity, and is spaced from the sixth wall with a third air gap being formed therebetween.

In an embodiment of the disclosure, the first resonator rod, the second resonator rod, and the third resonator rod are integrally formed with the metal cavity from a sheet material by a thin-wall processing technology.

In an embodiment of the disclosure, the sheet material is made of metal or non-metal base with a metallized surface.

In an embodiment of the disclosure, the thin-wall processing technique is stretching, cold heading, die-casting, or injection molding.

In an embodiment of the disclosure, the first dielectric body and/or the second dielectric body and/or the third dielectric body is/are made of material with high dielectric constant and low loss, such as ceramic.

According to a second aspect of the disclosure, there is provided a filter comprising a plurality of resonators, wherein at least one resonator is the above-mentioned cavity resonator.

In an embodiment of the disclosure, a wall of the at least one resonator, which forms a separator with respect to an adjacent resonator, has a window to provide a coupling between the at least one resonator and the adjacent resonator.

In an embodiment of the disclosure, at least two resonators are integrally formed from a single sheet material by a thin-wall processing technology, and a separator having a window is provided to form a coupling between adjacent resonators of the at least two resonators.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1A and FIG. 1B show a dual-mode cavity resonator according to a first embodiment of the present disclosure;

FIG. 2 shows a dual-mode cavity resonator according to a second embodiment of the present disclosure;

FIG. 3A and FIG. 3B each show a dual-mode cavity resonator according to a third embodiment of the present disclosure;

FIG. 4A and FIG. 4B each show a dual-mode cavity resonator according to a fourth embodiment of the present disclosure;

FIGS. 5A-5E each show a dual-mode cavity resonator according to a fifth embodiment of the present disclosure;

FIG. 6A and FIG. 6B each show a dual-mode cavity resonator according to a sixth embodiment of the present disclosure;

FIG. 7 shows a dual-mode cavity resonator according to a seventh embodiment of the present disclosure;

FIG. 8 shows a filter according to an embodiment of the present disclosure;

FIG. 9A and FIG. 9B show a method for producing the filter shown in FIG. 8;

FIG. 10A and FIG. 10B show another method for producing the filter shown in FIG. 8;

FIG. 11 shows a tuning method of the filter shown in FIG. 8;

FIG. 12 shows another tuning method of the filter shown in FIG. 8;

FIG. 13 shows a triple-mode cavity resonator according to an embodiment of the present disclosure;

FIG. 14 shows a triple-mode cavity resonator according to another embodiment of the present disclosure;

FIG. 15 shows a triple-mode cavity resonator according to a further embodiment of the present disclosure.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

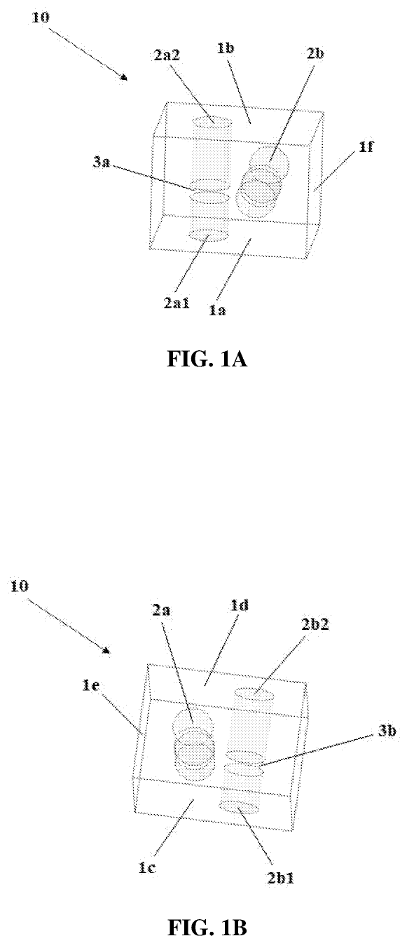

FIG. 1A and FIG. 1B show a dual-mode cavity resonator according to a first embodiment of the present disclosure. The dual-mode cavity resonator 10 comprises a metal cavity 1 and two resonator rods 2a, 2b arranged in the metal cavity 1. The metal cavity 1 is substantially in the shape of a cube or cuboid and has six walls. The metal cavity 1 is made of metal or non-metal base with a metallized surface. A first resonator rod 2a extends in a first direction between a first wall 1a and a second wall 1b of the metal cavity 1. A second resonator rod 2b extends in a second direction between a third wall 1c and a fourth wall 1d of the metal cavity 1. The second direction is perpendicular to the first direction. In contrast to conventional dual-mode cavity resonators in which a resonator body is provided in the shape of a cross, the first resonator rod 2a and the second resonator rod 2b do not intersect each other.

In the first embodiment, the first resonator rod 2a comprises a first part 2a1 extending from the first wall 1a of the metal cavity 1 and a second part 2a2 extending from the second wall 1b of the metal cavity 1. A first air gap 3a is formed between the first part 2a1 and the second part 2a2, and can be located at any position between the first wall 1a and the second wall 1b of the metal cavity 1. The second resonator rod 2b comprises a first part 2b1 extending from the third wall 1c of the metal cavity 1 and a second part 2b2 extending from the fourth wall 1d of the metal cavity 1. A second air gap 3b is formed between the first part 2b1 and the second part 2b2, and can be located at any position between the third wall 1c and the fourth wall 1d of the metal cavity 1. Thus, both ends of each of the first resonator rod 2a and the second resonator rod 2b are connected to corresponding walls of the metal cavity 1, that is, are grounded.

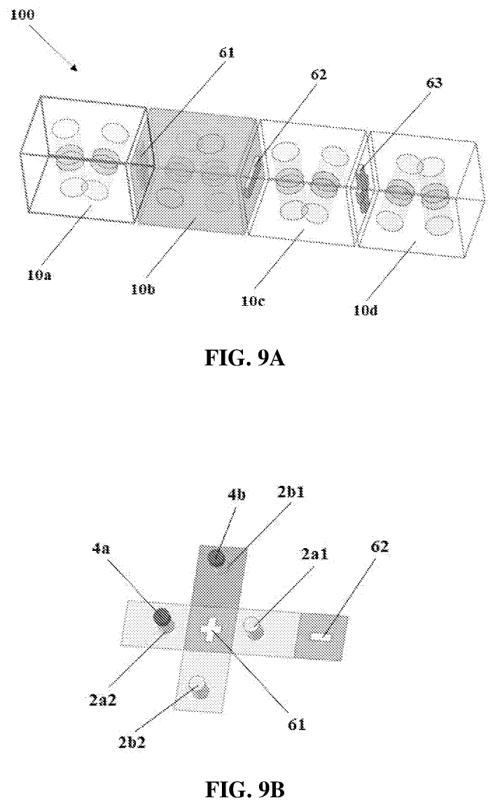

Each of the first resonator rod 2a and the second resonator rod 2b may be integrally formed with the metal cavity 1 from a sheet material by a thin-wall processing technology, such as stretching, cold heading, die-casting, or injection molding. For example, the first and second parts 2a1, 2a2 of the first resonator rod 2a are formed by stretching the sheet material at two predetermined portions, the first and second parts 2b1, 2b2 of the second resonator rod 2b are formed by stretching the sheet material at other two predetermined portions, and the first resonator rod 2a and the second resonator rod 2b are formed by folding the sheet material such that the first part 2a1 faces to and is spaced from the second part 2a2 and the first part 2b1 faces to and is spaced from the second part 2b2. In this connection, reference can be made to FIG. 9B which will be discussed later. Because each resonator rod is formed by stretching the sheet material at two portions, the extent of stretching can be reduced, so that it is easy to integrally form the resonator rod even if the height or length thereof is relatively large.

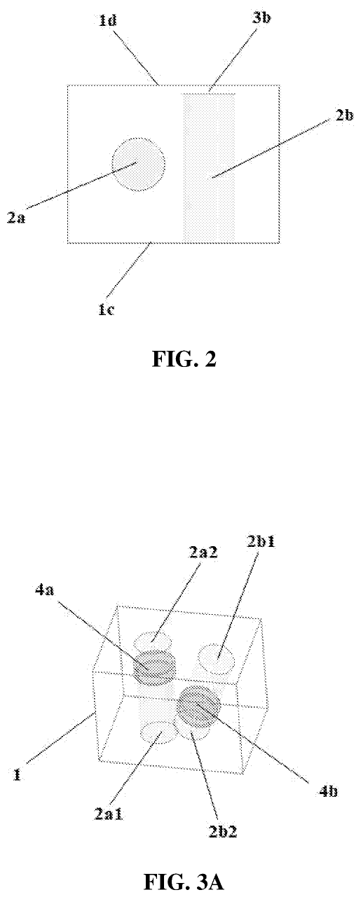

FIG. 2 shows a dual-mode cavity resonator according to a second embodiment of the present disclosure. The second embodiment differs from the first embodiment in that only one end of each of the first resonator rod 2a and the second resonator rod 2b is grounded, that is, connected to a corresponding wall of the metal cavity 1. Specifically, the first resonator rod 2a extends from the first wall 1a of the metal cavity 1 towards the second wall 1b of the metal cavity 1, and is spaced from the second wall 1b with a first air gap (not shown) being formed therebetween. The second resonator rod 2b extends from the third wall 1c of the metal cavity 1 towards the fourth wall 1d of the metal cavity 1, and is spaced from the fourth wall 1d with a second air gap 3b being formed therebetween.

Like in the first embodiment, each of the first resonator rod 2a and the second resonator rod 2b may be integrally formed with the metal cavity 1 from a sheet material by a thin-wall processing technology, such as stretching, cold heading, die-casting, or injection molding. For example, the first resonator rod 2a is formed by stretching the sheet material at a predetermined portion, and the second resonator rod 2b is formed by stretching the sheet material at another predetermined portion. The second embodiment is applicable if the height or length of the resonator rod is relatively small.

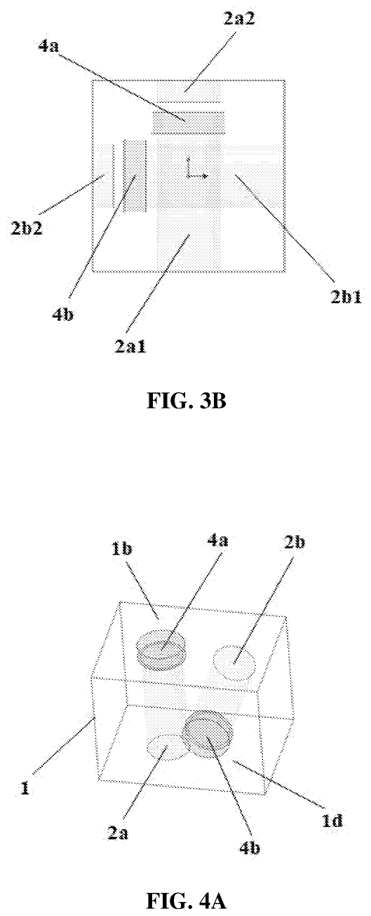

FIG. 3A and FIG. 3B each show a dual-mode cavity resonator according to a third embodiment of the present disclosure. The third embodiment differs from the first embodiment in that a first dielectric chip 4a is provided at the first air gap 3a and a second dielectric chip 4b is provided at the second air gap 3b. The first dielectric chip 4a may be grounded at one end or both ends thereof in the first direction, and the second dielectric chip 4b may be grounded at one end or both ends thereof in the second direction.

For example, a first end of the first dielectric chip 4a in the first direction is connected to the first part 2a1 of the first resonator rod 2a, and a first end of the second dielectric chip 4b in the second direction is connected to the first part 2b1 of the second resonator rod 2b. An opposite second end of the first dielectric chip 4a in the first direction may be connected to the second part 2a2 of the first resonator rod 2a, and an opposite second end of the second dielectric chip 4b in the second direction may be connected to the second part 2b2 of the second resonator rod 2b, as shown in FIG. 3A. Alternatively, the second end of the first dielectric chip 4a may be spaced from the second part 2a2 of the first resonator rod 2a, and the second end of the second dielectric chip 4b may be spaced from the second part 2b2 of the second resonator rod 2b, as shown in FIG. 3B.

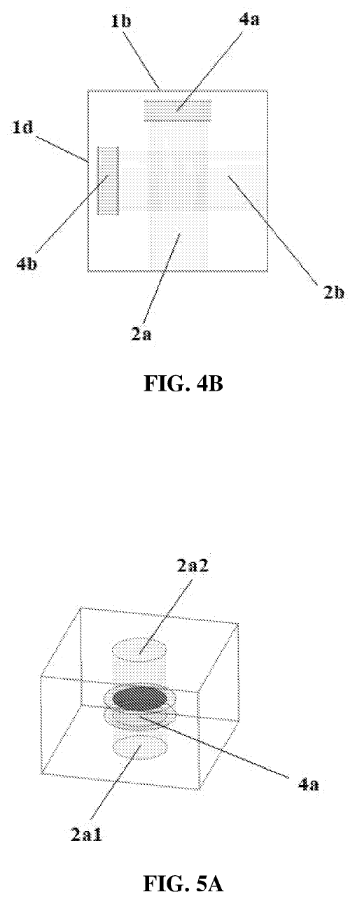

FIG. 4A and FIG. 4B each show a dual-mode cavity resonator according to a fourth embodiment of the present disclosure. The fourth embodiment differs from the second embodiment in that a first dielectric chip 4a is provided at the first air gap 3a and a second dielectric chip 4b is provided at the second air gap 3b. Like in the third embodiment, the first dielectric chip 4a may be grounded at one end or both ends thereof in the first direction, and the second dielectric chip 4b may be grounded at one end or both ends thereof in the second direction.

For example, a first end of the first dielectric chip 4a in the first direction is connected to the first resonator rod 2a, and a first end of the second dielectric chip 4b in the second direction is connected to the second resonator rod 2b. An opposite second end of the first dielectric chip 4a in the first direction may be connected to the second wall 1b of the metal cavity 1, and an opposite second end of the second dielectric chip 4b in the second direction may be connected to the fourth wall 1d of the metal cavity 1, as shown in FIG. 4A. Alternatively, the second end of the first dielectric chip 4a may be spaced from the second wall 1b of the metal cavity 1, and the second end of the second dielectric chip 4b may be spaced from the fourth wall 1d of the metal cavity 1, as shown in FIG. 4B.

In the third embodiment and the fourth embodiment, each of the first dielectric chip 4a and the second dielectric chip 4b is made of material with high dielectric constant and low loss, such as ceramic, which can get a higher single cavity Q value. The first dielectric chip 4a and the second dielectric chip 4b can be round, square, or in other shapes, and the cross area thereof can be less than, equal to, or larger than the cross area of the resonant rod 2a or 2b. The first dielectric chip 4a and the second dielectric chip 4b can effectively reduce the resonant frequency of the respective resonator rod 2a, 2b.

In the third embodiment and the fourth embodiment, the first end of the first dielectric chip 4a or the second dielectric chip 4b may be fixed to an end of (the first part 2a1 of) the first resonator rod 2a or (the first part 2b1 of) the second resonator rod 2b by welding or by using conductive glue. Similarly, the second end of the first dielectric chip 4a or the second dielectric chip 4b may be fixed to an end of the second part 2a2 of the first resonator rod 2a or the second part 2b2 of the second resonator rod 2b, or to the second wall 1b or the fourth wall 1d of the metal cavity 1, by welding or by using conductive glue.

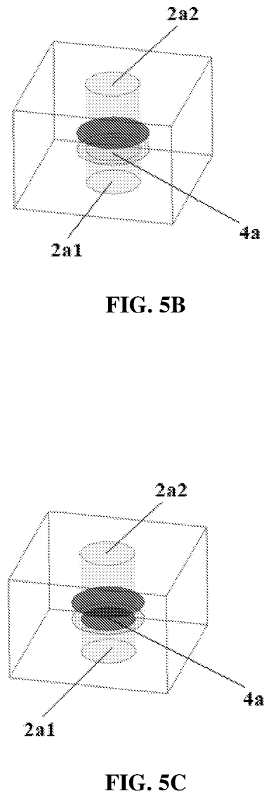

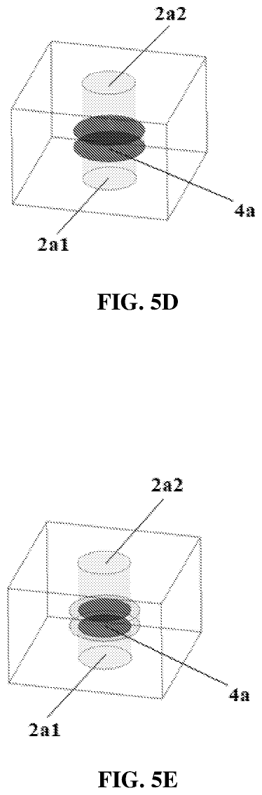

FIGS. 5A-5E each show a dual-mode cavity resonator according to a fifth embodiment of the present disclosure. The fifth embodiment differs from the third or fourth embodiment mainly in that the first dielectric chip 4a and/or the second dielectric chip 4b is/are electroplated. It should be noted that only the first resonator rod 2a and its surroundings are shown in FIGS. 5A-5E, and the second resonator rod 2b and its surroundings are omitted for clarity. It will be appreciated by those skilled in the art that the following description of features regarding the first resonator rod 2a also applies to the second resonator rod 2b which is not shown.

In FIG. 5A, a first end surface of the first dielectric chip 4a that is welded to the second part 2a2 of the first resonator rod 2a is partially electroplated, and a second end surface of the first dielectric chip 4a that is welded to the first part 2a1 of the first resonator rod 2a is not electroplated. In FIG. 5B, the first end surface of the first dielectric chip 4a is wholly electroplated, and the second end surface of the first dielectric chip 4a is not electroplated. In FIG. 5C, the first end surface of the first dielectric chip 4a is wholly electroplated, and the second end surface of the first dielectric chip 4a is partially electroplated. In FIG. 5D, the first end surface of the first dielectric chip 4a and the second end surface of the first dielectric chip 4a are both wholly electroplated, and each electroplating area of the first dielectric chip 4a is larger than a surface area of the first resonator rod 2a. In FIG. 5E, the first end surface of the first dielectric chip 4a and the second end surface of the first dielectric chip 4a are both partially electroplated, and each electroplating area of the first dielectric chip 4a is smaller than the surface area of the first resonator rod 2a.

It will be appreciated by those skilled in the art that any of the first and second end surfaces of the first dielectric chip 4a may be partially or wholly electroplated and may have an electroplating area smaller than, equal to, or larger than the surface area of the first resonator rod 2a. Generally, the side surface of the first dielectric chip 4a does not need to be electroplated.

In the embodiments shown in FIGS. 5A-5E, two ends of the first dielectric chip 4a are welded to the first and second parts 2a1, 2a2 of the first resonator rod 2a, respectively. However, the electroplating of the first dielectric chip 4a or the second dielectric chip 4b is not limited to this application scenario. For example, the first end surface of the first dielectric chip 4a may be welded to the second wall 1b of the metal cavity 1 (as shown in FIG. 4A), or may be spaced from the second parts 2a2 of the first resonator rod 2a (as shown in FIG. 3B) or the second wall 1b of the metal cavity 1 (as shown in FIG. 4B). In the latter two cases, only the second end surface of the first dielectric chip 4a needs to be wholly or partially electroplated.

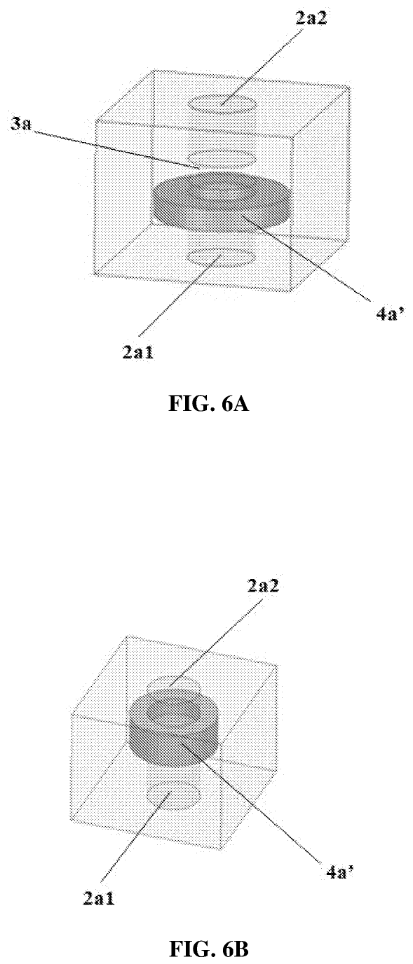

FIG. 6A and FIG. 6B each show a dual-mode cavity resonator according to a sixth embodiment of the present disclosure. In the sixth embodiment, the first dielectric chip 4a and the second dielectric chip 4b in the above embodiments are replaced with a first dielectric collar 4a′ and second dielectric collar, respectively. It should be noted that only the first resonator rod 2a and its surroundings are shown in FIGS. 6A and 6B, and the second resonator rod 2b and its surroundings are omitted for clarity. It will be appreciated by those skilled in the art that the following description of features regarding the first resonator rod 2a also applies to the second resonator rod 2b which is not shown.

The first dielectric collar 4a′ shown in FIG. 6A encircles a portion of the first part 2a1 of the first resonator rod 2a. The first dielectric collar 4a′ shown in FIG. 6B takes the form of a cap, having an inner end surface facing an end surface of the first part 2a1 of the first resonator rod 2a, and an annular side surface encircling a portion of the first part 2a1 of the first resonator rod 2a. It will be appreciated by those skilled in the art that the first dielectric collar 4a′ may be disposed to encircle a portion of the second part 2a2 of the first resonator rod 2a.

The first dielectric collar 4a′ can reduce the resonant frequency of the first resonator rod 2a. To further reduce the resonant frequency, the side surface of the cap-shaped first dielectric collar 4a′ shown in FIG. 6B may be at least partially electroplated. In addition, the inner end surface of the cap-shaped first dielectric collar 4a′ may be welded to the end surface of the first part 2a1 of the first resonator rod 2a, and in this case the inner end surface of the cap-shaped first dielectric collar 4a′ is also at least partially electroplated.

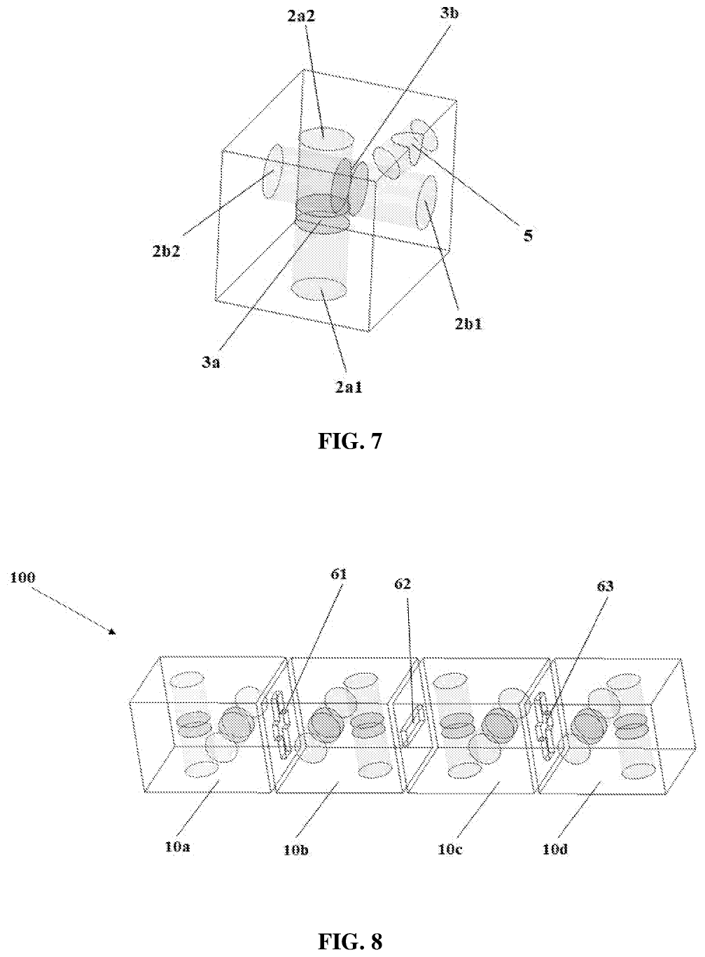

FIG. 7 shows a dual-mode cavity resonator according to a seventh embodiment of the present disclosure. The seventh embodiment differs from the above embodiments mainly in that a metal part or a metallization structure 5 is provided. For example, the metallization structure 5 may take the form of a cylinder, which intersects one of four edges of the metal cavity 1 that are perpendicular to the first and second resonator rods 2a, 2b, and the axis of which is perpendicular to the one edge. The metallization structure 5 forms an angle of 30-60 degree, preferably about 45 degree, with each of the first resonator rod 2a extending in the first direction and the second resonator rod 2b extending in the second direction. Thus, the metallization structure 5 can perturb the two modes of the dual-mode cavity resonator to realize coupling between the two modes.

FIG. 8 shows a filter according to an embodiment of the present disclosure. The filter 100 in this embodiment comprising four resonators 10a, 10b, 10c, 10d, and each of the four resonators is a dual-mode cavity resonator as described above. The number of the resonators is only an example, and can be changed as needed to influence the near band attenuation or selectivity of the filter. In addition, some of the resonators may be a single-mode resonator. As shown in FIG. 8, adjacent resonators 10a and 10b are separated by a wall having a window 61, adjacent resonators 10b and 10c are separated by a wall having a window 62, and adjacent resonators 10c and 10d are separated by a wall having a window 63. The windows 61, 62, 63 can function to provide a coupling between the adjacent resonators 10a, 10b, 10c, 10d.

FIG. 9A and FIG. 9B show a method for producing the filter 100 shown in FIG. 8. According to this method, the resonators 10a, 10b, 10c, 10d are separately produced, and then welded together to form the filter 100. For example, the resonator 10b is produced by stretching and folding a metal sheet as shown in FIG. 9B. Specifically, the metal sheet which is substantially in the shape of a cross is stretched at four locations to form the first and second parts 2a1, 2a2, 2b1, 2b2 of two resonator rods 2a, 2b, the first dielectric chip 4a is welded to one of the first and second parts 2a1, 2a2 (for example, 2a2) of the first resonator rods 2a, and the second dielectric chip 4b is welded to one of the first and second parts 2b1, 2b2 (for example, 2b1) of the second resonator rods 2b. Two windows 61, 62 are formed by cutting off a portion of the metal sheet at two locations. Then, the resonator 10b is formed by folding the metal sheet and welding at edges of the metal cavity. Finally, four resonators 10a, 10b, 10c, 10d are welded together to form the filter 100.

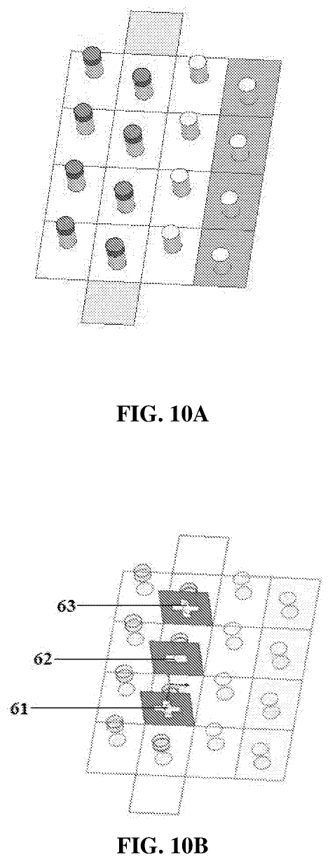

FIG. 10A and FIG. 10B show another method for producing the filter 100 shown in FIG. 8. According to this method, the resonators 10a, 10b, 10c, 10d are integrally formed from a single sheet material by a thin-wall processing technology, as shown in FIG. 10A. Three separators each having a window 61, 62, 63 are provided and weld to the sheet material as shown in FIG. 10B, so as to form a coupling between adjacent resonators 10a, 10b, 10c, 10d.

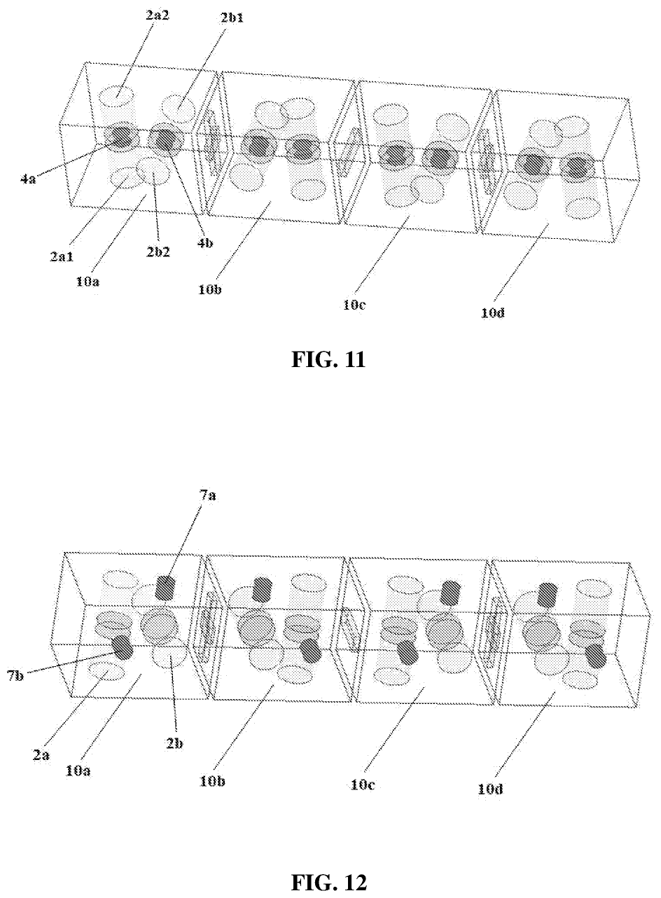

FIG. 11 shows a tuning method of the filter 100 shown in FIG. 8. A first central hole is formed at an end of the first and second parts 2a1, 2a2 of the first resonator rod 2a, such that an electroplated layer of the first dielectric chip 4a is exposed and can be partially removed for frequency tuning. A second central hole is formed at an end of the first and second parts 2b1, 2b2 of the second resonator rod 2b, such that an electroplated layer of the second dielectric chip 4b is exposed and can be partially removed for frequency tuning.

FIG. 12 shows another tuning method of the filter 100 shown in FIG. 8. A tuning screw 7a is provided at the first wall 1a and/or the second wall 1b of the metal cavity, adjacent to and substantially parallel to the first resonator rod 2a. A tuning screw 7b is provided at the third wall 1c and/or the fourth wall 1d of the metal cavity, adjacent to and substantially parallel to the second resonator rod 2b. Each of the tuning screws 7a, 7b may be replaced with a tuning tab integrally formed with the metal cavity.

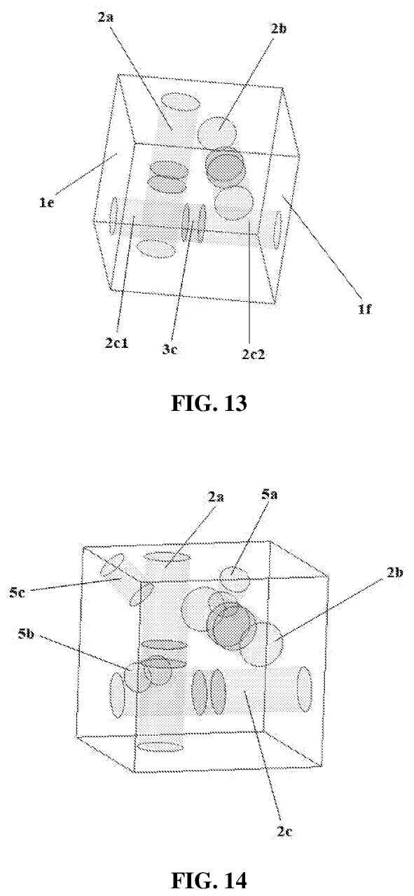

FIG. 13 shows a triple-mode cavity resonator according to an embodiment of the present disclosure. In addition to the first resonator rod 2a and the second resonator rod 2b as described above, the triple-mode cavity resonator further comprises a third resonator rod 2c extending in a third direction between a fifth wall 1e and a sixth wall 1f of the metal cavity 1. The third direction is perpendicular to the first direction and the second direction. The third resonator rod 2c does not intersect the first resonator rod 2a or the second resonator rod 2b, and is provided with a third dielectric body (not shown). The third resonator rod 2c is grounded. In this embodiment, the third resonator rod 2c comprises a first part 2c1 extending from the fifth wall 1e of the metal cavity 1 and a second part 2c2 extending from the sixth wall 1f of the metal cavity 1, with a third air gap 3c being formed therebetween. In another embodiment, the third resonator rod 2c extends from the fifth wall 1e of the metal cavity 1 towards the sixth wall 1f of the metal cavity 1, and is spaced from the sixth wall 1f with a third air gap 3c being formed therebetween.

FIG. 14 shows a triple-mode cavity resonator according to another embodiment of the present disclosure. In this embodiment, a first metallization structure 5a is provided to realize coupling between two modes relating to the first and second resonator rods 2a, 2b, a second metallization structure 5b is provided to realize coupling between two modes relating to the second and third resonator rods 2b, 2c, and a third metallization structure 5c is provided to realize coupling between two modes relating to the first and third resonator rods 2a, 2c. Each of the metallization structure 5a, 5b, 5c takes the form of a cylinder, as in the above seventh embodiment of the dual-mode cavity resonator shown in FIG. 7.

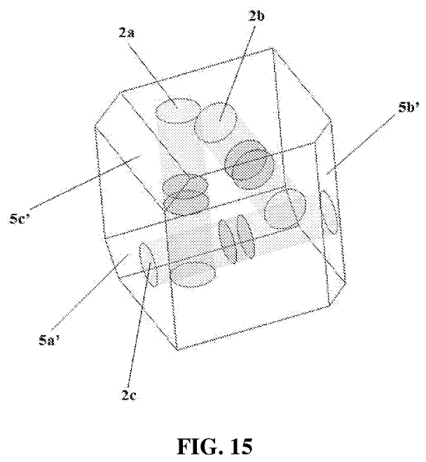

FIG. 15 shows a triple-mode cavity resonator according to a further embodiment of the present disclosure. In this embodiment, each of the three metallization structures 5a′, 5b′, 5c′, which are provided to realize coupling between two of the three modes, takes the form of a chamfer.

According to the present disclosure, two or three resonator rods that are perpendicular to each other and do not intersect each other are located in a metal cavity. Thus, a novel and improved dual-mode or triple-mode cavity resonator is provided. In the resonator, each of the resonator rods is connected to a corresponding wall of the metal cavity so that the resonator rods can be integrally formed with the metal cavity. In addition, a dielectric body, such as a dielectric chip or a dielectric collar, can be disposed at any position in the direction in which the respective resonator rod extends, which can effectively reduce the resonant frequency.

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A cavity resonator, comprising:
a metal cavity;
a first resonator rod extending in a first direction between a first wall and a second wall of the metal cavity; and
a second resonator rod extending in a second direction between a third wall and a fourth wall of the metal cavity, the second direction being perpendicular to the first direction,
wherein the first resonator rod and the second resonator rod do not intersect each other, the first resonator rod is provided with a first dielectric body, and the second resonator rod is provided with a second dielectric body.

2. The cavity resonator according to claim 1, wherein each of the first resonator rod and the second resonator rod is grounded.

3. The cavity resonator according to claim 2, wherein:
the first resonator rod comprises a first part extending from the first wall of the metal cavity and a second part extending from the second wall of the metal cavity, with a first air gap being formed therebetween; and/or
the second resonator rod comprises a first part extending from the third wall of the metal cavity and a second part extending from the fourth wall of the metal cavity, with a second air gap being formed therebetween.

4. The cavity resonator according to claim 2, wherein:
the first resonator rod extends from the first wall of the metal cavity towards the second wall of the metal cavity, and is spaced from the second wall with a first air gap being formed therebetween; and/or
the second resonator rod extends from the third wall of the metal cavity towards the fourth wall of the metal cavity, and is spaced from the fourth wall with a second air gap being formed therebetween.

5. The cavity resonator according to claim 3, wherein:
the first dielectric body is a first dielectric chip provided at the first air gap; and/or
the second dielectric body is a second dielectric chip provided at the second air gap.

6. The cavity resonator according to claim 5, wherein:
the first dielectric chip is grounded at one end or both ends thereof in the first direction; and/or
the second dielectric chip is grounded at one end or both ends thereof in the second direction.

7. The cavity resonator according to claim 5, wherein:
the first dielectric chip is fixed to an end of the first resonator rod by welding; and/or
the second dielectric chip is fixed to an end of the second resonator rod by welding.

8. The cavity resonator according to claim 7, wherein:
one end surface or both end surfaces of the first dielectric chip in the first direction is/are at least partially electroplated; and/or
one end surface or both end surfaces of the second dielectric chip in the second direction is/are at least partially electroplated.

9. The cavity resonator according to claim 8, wherein:
an electroplating area of the first dielectric chip is smaller than, equal to, or larger than a surface area of the first resonator rod; and/or
an electroplating area of the second dielectric chip is smaller than, equal to, or larger than a surface area of the second resonator rod.

10. The cavity resonator according to claim 8, wherein:
a first central hole is formed at an end of the first resonator rod, such that an electroplated layer of the first dielectric chip can be partially removed for frequency tuning; and/or
a second central hole is formed at an end of the second resonator rod, such that an electroplated layer of the second dielectric chip can be partially removed for frequency tuning.

11. The cavity resonator according to claim 5, wherein:
the first dielectric chip is fixed to an end of the first resonator rod by using conductive glue; and/or
the second dielectric chip is fixed to an end of the second resonator rod by using conductive glue.

12. The cavity resonator according to claim 3, wherein:
the first dielectric body is a first dielectric collar that encircles a portion of the first resonator rod; and/or
the second dielectric body is a second dielectric collar that encircles a portion of the second resonator rod.

13. The cavity resonator according to claim 12, wherein:
the first dielectric collar takes the form of a cap, having an inner end surface facing an end surface of the first resonator rod in the first direction; and/or
the second dielectric collar takes the form of a cap, having an inner end surface facing an end surface of the second resonator rod in the second direction.

14. The cavity resonator according to claim 12, wherein:
the first dielectric collar is at least partially electroplated; and/or
the second dielectric collar is at least partially electroplated.

15. The cavity resonator according to claim 3, wherein:
a tuning screw or a tuning tab is provided at the first wall and/or the second wall, adjacent to the first resonator rod; and/or
a tuning screw or a tuning tab is provided at the third wall and/or the fourth wall, adjacent to the second resonator rod.

16. The cavity resonator according to claim 1, further comprising a metal part or a metallization structure, which forms an angle of 30-60 degree with the first direction and the second direction.

17. The cavity resonator according to claim 1, further comprising a third resonator rod extending in a third direction between a fifth wall and a sixth wall of the metal cavity, the third direction being perpendicular to the first direction and the second direction,
wherein the third resonator rod does not intersect the first resonator rod or the second resonator rod, and is provided with a third dielectric body.

18. The cavity resonator according to claim 17, wherein the third resonator rod is grounded.

19. The cavity resonator according to claim 18, wherein:
the third resonator rod comprises a first part extending from the fifth wall of the metal cavity and a second part extending from the sixth wall of the metal cavity, with a third air gap being formed therebetween; or
the third resonator rod extends from the fifth wall of the metal cavity towards the sixth wall of the metal cavity, and is spaced from the sixth wall with a third air gap being formed therebetween.

20-23. (canceled)

24. A filter (400), comprising a plurality of resonators, wherein at least one resonator is the cavity resonator according to claim 1.

25-26. (canceled)
